(19) United States
(12) Patent Application Publication
(10) Pub. No.: US 2007/0166490 A1
(43) Pub. Date: Jul. 19, 2007

(54) Transparent and colored container

(75) Inventors: Subir K. Dey, Florence, SC (US); J. Mark Morrow, Camden, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 11/332,412

(22) Filed: Jan. 13, 2006

(51) Int. Cl. B32B 27/08

(52) U.S. Cl. 428/35.7

(57) ABSTRACT

The present invention provides a container having an improved clarity and color. The container includes a multi-layered wall. The wall may have one or more polypropylene layers, one or more ethylene-vinyl alcohol layers, and one or more tie layers. The tie layers include an adhesive or adhesive mixture for bonding adjacent polypropylene and ethylene-vinyl alcohol layers. The adhesive mixture may include a mixture of polypropylene and maleated polypropylene. Polypropylene in one or more of the layers including the tie layers may be of a clarified grade. A colorant may be added to one or more of the layers. For example, a transparent polymeric colorant may be added to one or more of the polypropylene layers. A dye may be added to a polypropylene layer wherein adjacent ethylene-vinyl alcohol layers inhibit the dye from migrating out of the polypropylene layer.

### BACKGROUND OF THE INVENTION

The present invention relates to multi-layered plastic containers. More particularly the present invention relates to containers having a transparent and colored body.

Plastic containers or other plastic structures are often used to store food products. Polypropylene is a common material used for such containers because of its mechanical and thermal properties. However, polypropylene has inadequate gas barrier properties by itself. Therefore, it is typical for polypropylene to be part of a composite container comprising multiple layers. For example, a container often has one or more layers of polypropylene and one or more layers of a barrier material. Barrier materials include EVOH, nylon, PVDC, or other materials having relatively high barrier properties.

The containers typically include tie layers for adhering the polypropylene layers and barrier material layers together. Maleated polypropylene is a common tie layer.

Often for marketing and general aesthetic purposes, it is desirable for the container to be transparent or colored. However, polypropylene is opaque because of differences in refractive indices between the amorphous phase and the crystalline phase. The clarification of polypropylene may be improved with the use of clarifying agents. However, clarifying agents generally are not effective with maleated polypropylene. Therefore, tie layers often contribute greatly to haze in a container.

Colorants, such as pigments or dyes, are applied to some plastics to provide the plastics with a particular color. Pigments are insoluble while dyes are soluble in polymers. Polypropylene has a chemical structure that does not accept coloring dye well. Furthermore, pigments usually compromise the clarity of polypropylene.

### BRIEF SUMMARY OF THE INVENTION

The present invention aims to address one or more of the above problems. The present invention provides a multi-layered container having improved clarity and color. The container defines an interior for storing product, such as food products. The wall of the container includes at least a first layer, a second layer, and a third layer. According to an embodiment of the present invention, the first layer comprises an ethylene-vinyl alcohol resin. The second layer comprises a polypropylene resin and a colorant. The third layer comprises an ethylene-vinyl alcohol resin. It is believed that the first and third layers inhibit the colorant of the second layer from migrating away from the second layer and into the first layer and the third layer.

According to some embodiments, the colorant may be a dye and the polypropylene resin may include a clarifying agent. The second layer may further include a maleated polypropylene to promote bonding between the second layer and the first and third layers.

According to another embodiment of the present invention, the container includes one or more polypropylene layers, one or more ethylene-vinyl alcohol layers, and at least one tie layer. At least one of the polypropylene layers includes a transparent polymeric colorant. The tie layer or layers promote bonding between the polypropylene layers and the ethylene-vinyl alcohol layers. The tie layers may include a mixture of a polypropylene and a maleated polypropylene. For example, the tie layer may include a polypropylene and a maleated polypropylene mixture of approximately one to one. The polypropylene in one or more polypropylene layers or tie layers made include a clarifying agent.

In yet another embodiment, the present invention provides a multi-layered container having a first layer of a polypropylene resin of a clarified grade, a second layer of a polypropylene resin of a clarified grade, and a tie layer of an adhesive mixture for bonding the first layer to the second layer, the mixture including a polypropylene of a clarified grade and a maleated polypropylene. At least one of the layers includes a transparent polymeric colorant. The polypropylene resin of the first layer and the second layer and the polypropylene in the tie layer may be substantially the same. The container may include additional layers of the polypropylene resin of a clarified grade.

According to another embodiment, the multi-layered container includes first and second layers of a polypropylene resin of a clarified grade, a first tie layer and a second tie layer of an adhesive mixture, and a layer of an ethylene-vinyl alcohol resin. The layer of the ethylene-vinyl alcohol resin is bonded to the first layer and the second layer of the polypropylene resin by the first and second tie layers, respectively.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a container;

FIG. 2 is a sectional view of a wall of the container shown in FIG. 1, according to an embodiment of the present invention;

FIG. 3 is a sectional view of the wall of the container shown in FIG. 1, according to another embodiment of the present invention;

FIG. 4 is a sectional view of the wall of the container shown in FIG. 1, according to yet another embodiment of the present invention; and

FIG. 5 is a sectional view of the wall of the container shown in FIG. 1, according to an additional embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

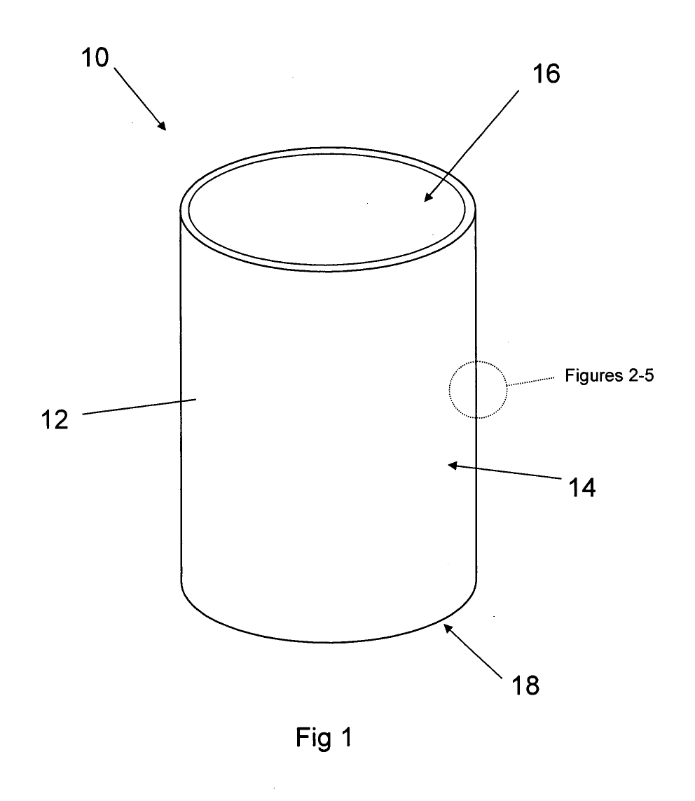

The present invention provides a container having improved clarity and color. The container includes a multi-layered wall that defines an interior for receiving and storing articles such as food products or beverages. As shown in FIG. 1, the wall 12 may further define a body portion 14 extending from an opening 16 to a base portion 18. The container 10 may further include a lid or other closure device (not shown) for closing the opening 16. The wall 12 may include a threaded area (not shown) proximate the opening 16 for engaging the lid. However, the engagement of the lid or other closure device to the rest of the container may vary. For example, the lid may be sealed or adhered to the wall 12 of the container 10. Although the container is illustrated in FIG. 1 as being cylindrical in shape, the general shape of the container may vary.

As further described below, the wall includes two or more layers. For example, the wall may include one or more layers comprising an ethylene-vinyl alcohol resin, one or more layers comprising a polypropylene resin, and one or more tie layers comprising an adhesive or adhesive mixture. In general, adjacent polypropylene layers and ethylene-vinyl alcohol layers may be adhered together by the tie layers.

One aspect of the present invention is the clarity or transparency of the wall and, thus, the container. In order to improve the clarity of the wall, the polypropylene resin in one or more of the layers includes a clarifying agent. As used herein, a clarifying agent is an additive for increasing the transparency of the polypropylene. In general, clarifying agents are a sub-class of nucleating agents. For example, sorbitol derivatives or sorbitol acetals are clarifying agents. Sorbitol derivatives and other clarifying agents are available from Milliken & Company of Spartanburg, S.C. Also, as used herein a clarified grade of polypropylene is a polypropylene containing a clarifying agent.

The present invention also provides a tie layer formulated to minimize haze within the wall. For example, one or more tie layers may include an adhesive mixture of polypropylene and maleated polypropylene. The polypropylene may be of a clarified grade. The mixture may be formed by dry blending a polypropylene resin with a maleated polypropylene resin. It is believed that the maleated polypropylene provides an adhesive quality for encouraging the bonding between adjacent layers, while the mixture with the clarified polypropylene minimizes the negative contribution to the haze of the wall that is normally associated with conventional tie layers.

A tie layer according to an embodiment of the present invention was tested against a conventional tie layer. More specifically, a first sheet comprising a first layer of a polypropylene resin, an intermediate tie layer, and a second layer of a polypropylene resin was tested against a second sheet comprising a first layer of a polypropylene resin, an intermediate tie layer, and a second layer of a polypropylene resin. Each sheet had an overall thickness of 100 mils, wherein each first and second layer had a thickness of 48 mils and each intermediate layer had a thickness of 4 mils. In the first sheet, the intermediate tie layer included a maleated polypropylene. In the second sheet, the intermediate tie layer included a mixture of a polypropylene and a maleated polypropylene. The mixture was formed by dry blending the two together at a ratio of one to one by weight. For testing purposes, the polypropylene resin used in the layers, including the tie layer of the second sheet, was a clarified grade of a copolymer having a melt index of 2.2, density of 0.903 g/cc and tensile strength of 4500 psi. The maleated polypropylene used in both the tie layer of the first and second sheets was a copolymer having a melt index of 5.7, density of 0.89 g/cc, a melting point of 140° C., a 60D-shore hardness, and a stress at yield of 2600 psi. The clarity of each sheet was measured with the following results:

| Sheet description | Clarity for 100 mil sheet |
|---|---|
| 1^{st} Sheet - {PP/maleated PP/PP} | 74.2 |
| 2^{nd} Sheet - {PP/maleated PP + PP (50:50)/PP} | 96.8 |

The clarities were measured as a percent of light transmission by using BYK Gardner Haze-Gard Plus equipment. In general, the results indicate a 30% improvement in light transmission by blending maleated polypropylene and clarified polypropylene.

Another aspect of the present invention is providing the wall of the container with a color quality. One or more of the layers may include a colorant. The colorant may be a dye, a pigment, or other agent used to impart a color or shading to a material, such as polypropylene. Colorants are known in the art and available through companies such as Milliken & Company of Spartanburg, S.C.; ColorMatrix Corporation of Berea, Ohio; Polyone Corporation of Avon Lake, Ohio; Ampacet Corporation of Tarrytown, Nev.; and others.

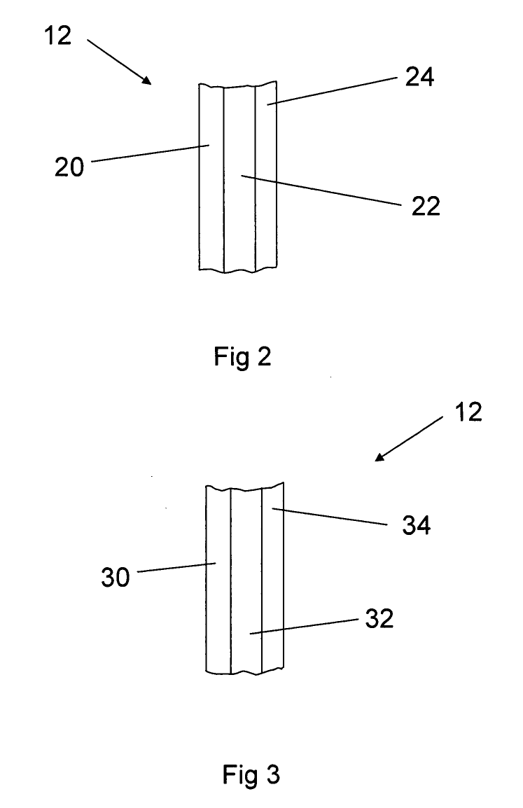

According to another embodiment of the present invention, the wall includes at least three layers. For example and as shown in FIG. 2, the wall 12 includes a first layer 20 comprising an ethylene-vinyl copolymer resin, a second layer 22 comprising a polypropylene resin and a colorant, such as a dye, and a third layer 24 comprising an ethylene-vinyl alcohol copolymer resin. It is believed that the ethylene-vinyl alcohol layers on either side of the polypropylene layer will inhibit the colorant from migrating out and away from the polypropylene layer.

The layer of polypropylene 22 may further include an adhesive, such as maleated polypropylene, for encouraging the second layer 22 to bond with the first and third layers 20, 24 of the ethylene-vinyl copolymer resin. Or the wall 12 may further include an adhesive between the layers 20, 22, 24 to encourage bonding. The polypropylene resin may be of a clarified grade.

According to yet another embodiment, the wall includes one or more polypropylene layers, one or more ethylene-vinyl alcohol layers, and at least one tie layer. The tie layer or layers are between adjacent polypropylene and ethylene-vinyl alcohol layers. The tie layers are for encouraging the adjacent polypropylene and ethylene-vinyl alcohol layers to bond together.

For example and as shown in FIG. 3, the wall 12 may include a first polypropylene layer 30, a tie layer 32, and a second polypropylene layer 34, i.e. {PP/tie layer/PP}. The tie layer 32 may include a mixture of a polypropylene and a maleated polypropylene. For example, the ratio of the polypropylene to the maleated polypropylene may be approximate one to one. Other examples include, but are not limited to, ratios of one to two, one to five, and one to ten of the polypropylene to the maleated polypropylene. The polypropylene resin in the polypropylene layers 30, 34 and in the tie layer 32 may be a clarified grade copolymer having approximately a melt index of 2.2, density of 0.903 g/cc, and a tensile strength of 4500 psi. The maleated polypropylene copolymer may have approximately a melt index of 5.7, density of 0.89 g/cc, melting point of 140° C., 60D-shore hardness and stress at yield of 2600 psi. Although not shown in FIG. 3, the wall may further include additional layers, including one or more layers of a barrier material, such as ethylene-vinyl alcohol.

The polypropylene resin characteristics may vary. Another example of a polypropylene resin is a clarified grade of metallocene homopolymer having approximately a melt index of 1.5, density of 0.9 g/cc, and a tensile strength of 4400 psi.

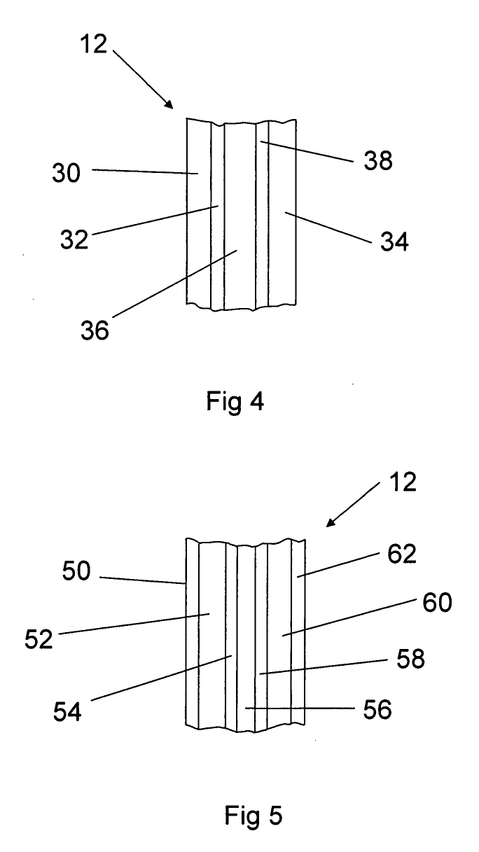

As shown in FIG. 4, the wall 12 may further include an ethylene-vinyl alcohol layer 36 and a second tie layer 38. For example, the wall 12 may having the following layers {PP/tie layer/EVOH/tie layer/PP}, wherein the tie layers 32, 38 include a mixture of polypropylene and maleated polypropylene. The ethylene-vinyl alcohol may contain approximately 28% ethylene and have approximately a density of 1.19 g/cc, a melting point of 189° C., crystallization temperature of 165° C. and a glass transition temperature of 71° C. Ethylene-vinyl alcohol containing other than 28% ethylene may also be used.

FIG. 5 illustrates another embodiment of the present invention. The wall 12 may include seven layers, referred to herein as the seven-layer embodiment. For example, starting with the innermost layer to the outermost layer, the wall 12 may include a first polypropylene layer 50, a second polypropylene layer 52, a first tie layer 54, a ethylene-vinyl alcohol layer 56, a second tie layer 58, a third polypropylene layer 60, and a fourth polypropylene layer 62, i.e. {PP/PP/tie layer/EVOH/tie layer/PP/PP}. The tie layers 54, 58 include an adhesive such as maleated polypropylene. The tie layers 54, 58 may further include a mixture of polypropylene and maleated polypropylene.

One or more of the polypropylene layers, including a tie layer, may include a colorant. For example, the colorant may be a transparent polymeric colorant provided by Milliken & Company sold under the trademark of ClearTint® colorant.

The seven-layer embodiment illustrated in FIG. 5 was tested for clarity and haze. Specifically for testing, the polypropylene in the layers and tie layers was a clarified grade copolymer having a melt index of 2.2, density of 0.903 g/cc and tensile strength of 4500 psi. The maleated polypropylene in the tie layers was a copolymer having a melt index of 5.7, density of 0.89 g/cc, melting point of 140° C., 60D-shore hardness, and stress at yield of 2600 psi. The ethylene-vinyl alcohol copolymer contained 28% ethylene, density of 1.19 g/cc, melting point of 189° C. and glass transition temperature of 71° C. The seven-layers were co-extruded into sheets, trimmed to a 19″ width and rolled onto a 6″ diameter core. Each sheet was thermoformed into a 32 oz. container. The overall thickness of each sheet was about 65 mils before the thermoforming process. In particular, the layers made the following contribution to the overall thickness of the sheets, each first and fourth polypropylene layer 50, 62 was 16% of the overall thickness, each third and each fourth polypropylene layer 52, 60 was 25% of the overall thickness, each first and second tie layer 54, 58 was 4% of the overall thickness, and each ethylene-vinyl alcohol layer 56 was 10% of the overall thickness.

Three types of sheets were tested based on the colorant added or lack thereof to the first and fourth polypropylene layers 50, 62. In the clear sheets, no colorant was added to any of the layers. In the red sheets, the ClearTint® colorant in the shade of red was added to the first and fourth polypropylene layers 50, 62. In the blue sheets, the ClearTint® colorant in the shade of blue was added to the first and fourth polypropylene layers 50, 62. As stated, each sheet was thermoformed into a container and each container was tested for clarity and haze using a BYK Gardner Haze-gard Plus and an Illuminant CIE-C meter. The results are tabulated below, with the number after the color representing the overall measured thickness in mils of the seven-layer wall.

| Container | Clarity | Haze |
|---|---|---|
| Clear 15 | 91.44 +/− 0.29 | 5.42 +/− 0.16 |
| Clear 13 | 92.52 +/− 0.16 | 4.77 +/− 0.14 |
| Red 14 | 87.40 +/− 0.56 | 5.19 +/− 0.44 |
| Red 15 | 78.4 +/− 0.52 | 5.66 +/− 0.41 |
| Blue 15 | 89.42 +/− 0.52 | 9.96 +/− 0.37 |
| Blue 16 | 87.54 +/− 1.22 | 6.99 +/− 0.35 |

One in the art would appreciate that a heat stabilizer, process stabilizer, optical brightener, light stabilizer, internal lubricant, external lubricant, or any other property modifier may be added to any of the above layers.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A multi-layered container having improved clarity and color and defining an interior, the container having a wall comprising:
a first layer comprising an ethylene-vinyl alcohol resin;
a second layer comprising a polypropylene resin and a colorant; and
a third layer comprising an ethylene-vinyl alcohol resin;
wherein the second layer is between the first layer and third layer such that the colorant of the second layer is inhibited from migrating away from the second layer and into the first layer and the third layer.

2. The container according to claim 1, wherein the colorant comprises a dye.

3. The container according to claim 1, wherein the polypropylene resin includes a clarifying agent.

4. The container according to claim 1, wherein the polypropylene resin includes a nucleating agent.

5. The container according to claim 1, wherein the second layer further comprises a maleated polypropylene for encouraging bonding between the second layer and the first and third layers.

6. A multi-layered container having improved clarity and color and defining an interior, the container having a wall comprising:
one or more polypropylene layers, wherein at least one of the polypropylene layers includes a transparent polymeric colorant;
one or more ethylene-vinyl alcohol layers; and
at least one tie layer for promoting bonding between at least one of the polypropylene layers and at least one of the ethylene-vinyl alcohol layers, the tie layer including a mixture of a polypropylene and a maleated polypropylene.

7. The container according to claim 6, wherein the mixture of the polypropylene and the maleated polypropylene is approximately one to one.

8. The container according to claim 6, wherein the mixture of the polypropylene and the maleated polypropylene is approximately one to two.

9. The container according to claim 6, wherein the polypropylene of the at least one tie layer and of the one or more polypropylene layers includes a clarifying agent.

10. The container according to claim 6, wherein the polypropylene of the at least one tie layer and of the one or more polypropylene layers includes a nucleating agent.

11. The container according to claim 6 further comprising a first polypropylene layer and a second polypropylene layer between a first ethylene-vinyl alcohol layer and the interior of the container, wherein the second polypropylene layer is between the first polypropylene layer and the first ethylene-vinyl alcohol layer.

12. The container according to claim 11 further comprising a third polypropylene layer and a fourth polypropylene layer, the third polypropylene layer and fourth polypropylene layer being on an opposite side of the first ethylene-vinyl alcohol layer from the interior of the container, wherein the third polypropylene layer is between the fourth polypropylene layer and the first ethylene-vinyl alcohol layer.

13. The container according to claim 12, wherein the first polypropylene layer and the fourth polypropylene layer include a transparent polymeric colorant.

14. The container according to claim 12, wherein each polypropylene layer includes a transparent polymeric colorant.

15. A multi-layered container having improved clarity and color, the container having a wall comprising:
a first layer of a polypropylene resin of a clarified grade;
a second layer of a polypropylene resin of a clarified grade; and
a tie layer of an adhesive mixture for bonding the first layer to the second layer, the mixture including a polypropylene of a clarified grade and a maleated polypropylene,
wherein at least one of the layers includes a transparent polymeric colorant.

16. The container according to claim 15, wherein the mixture of the polypropylene of a clarified grade and a maleated polypropylene is approximately one to one.

17. The container according to claim 15, wherein the polypropylene resin of the first layer, the polypropylene resin of the second layer, and the polypropylene of the adhesive mixture are substantially the same.

18. A multi-layered container having improved clarity and color, the container having a wall comprising:
a first layer of a polypropylene resin of a clarified grade;
a first tie layer of an adhesive mixture, the mixture including a polypropylene of a clarified grade and a maleated polypropylene;
a layer of a ethylene-vinyl alcohol resin, wherein the layer of the ethylene-vinyl alcohol resin is bonded to the first layer of the polypropylene resin by the first tie layer;
a second tie layer of an adhesive mixture, the mixture including a polypropylene of a clarified grade and a maleated polypropylene; and
a second layer of a polypropylene resin of a clarified grade, wherein the second layer of a polypropylene resin is bonded to the layer of the ethylene-vinyl alcohol resin by the second tie layer,
wherein at least one of the layers of the polypropylene resin of a clarified grade includes a transparent polymeric colorant.

19. The container according to claim 18, wherein the mixture of the polypropylene of a clarified grade and a maleated polypropylene in the first and second tie layers is approximately one to one.

20. The container according to claim 18, wherein the polypropylene resin of the first layer and of the second layer and the polypropylene in the first tie layer and the second lie layer are substantially the same.
